(19) United States
(12) Patent Application Publication
(10) Pub. No.: US 2004/0176998 A1
(43) Pub. Date: Sep. 9, 2004

(54) Method and system for selling an item over a computer network

(76) Inventors: Evan Kirshenbaum, Mountain View, CA (US); Mathias Salle, Palo Alto, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/378,813

(22) Filed: Mar. 5, 2003

(51) Int. Cl. G06F 17/60

(52) U.S. Cl. 705/14; 705/26; 705/27

(57) ABSTRACT

A method for purchasing rights to resell an item offers for sale a right to have purchased items, articles, or products shipped at a later date. The method offers for sale an item's ownership, without altering the physical location of the item. In other words, a customer pays to own the item without acquiring possession of the item. A merchant that sells the item, or the merchant's supplier, may retain possession of the item until the customer takes possession.

### CROSS-REFERENCE TO RELATED APPLICATIONS

This application is related to U.S. patent application Ser. No. ______ (Attorney Docket No. 200207986-1), entitled “METHOD AND SYSTEM FOR EVALUATING PERFORMANCE OF A WEBSITE USING A CUSTOMER SEGMENT AGENT TO INTERACT WITH THE WEBSITE ACCORDING TO A BEHAVIOR MODEL” to Cipriano SANTOS, et al.; U.S. patent application Ser. No. ______ (Attorney Docket No. 200207987-1), entitled “METHOD AND SYSTEM FOR CUSTOMIZED CONFIGURATION OF AN APPEARANCE OF A WEBSITE FOR A USER” to Evan KIRSHENBAUM, et al.; U.S. patent application Ser. No. ______ (Attorney Docket No. 200207988-1), entitled “SYSTEM, METHOD AND APPARATUS USING BIOMETRICS TO COMMUNICATE CUSTOMER DISSATISFACTION VIA STRESS LEVEL” to Carol McKENNAN, et al.; U.S. patent application Ser. No. ______ (Attorney Docket No. 200207991-1), entitled “APPARATUS AND METHOD FOR THEOREM CERTIFICATION WITHOUT DISCLOSING DOCUMENTS THAT LEAD TO THE THEOREM” to Mathias SALLE; U.S. patent application Ser. No. ______ (Attorney Docket No. 200207994-1), entitled “METHOD AND SYSTEM ENABLING THE TRADING OF A RIGHT TO PURCHASE GOODS OR SERVICES” to Robert C. VACANTE, et al.; U.S. patent application Ser. No. ______ (Attorney Docket No. 200207996-1), entitled “METHOD AND SYSTEM FOR PROCESSING USER FEEDBACK RECEIVED FROM A USER OF A WEBSITE” to Mathias SALLE, et al., and U.S. patent application Ser. No. ______ (Attorney Docket No. 200309361-1), entitled “A METHOD AND SYSTEM ENABLING THE TRADING OF A FUTURES CONTRACT FOR THE PURCHASE OF GOODS OR SERVICES” to Robert C. VACANTE, et al., all of which are concurrently herewith being filed under separate covers, the subject matters of which are herein incorporated by reference.

### TECHNICAL FIELD

The technical field relates to on-line commerce systems, and, in particular, to an on-line commerce system for selling an item over a computer network.

### BACKGROUND

With current Internet advancement, more and more products are being offered for sale on-line. FIGS. 1A and 1B illustrate current on-line trading of articles and products. Referring to FIG. 1A, when shopping for an item 152 either for personal consumption or for a gift, a customer X 122 or Y 124 looks up web sites sponsored by merchants A 112 or B 114 to find a best price. Each merchant 112, 114 typically has an inventory 142 that stocks the item 152 being offered for sale. After finding a good price, the customer 122, 124 commits to buy the item 152 and initiates shipment. FIG. 1B is a flow chart illustrating the prior art on-line product trading transaction. The merchant A 112 offers the item 152 for sale (block 160). The customer X 122 purchases the item 152 (block 162). Next, the customer X 122 requests shipment (block 164), the merchant A 112 ships the item 152 (block 168), and the customer X 122 receives the item 122 (block 170).

However, with current on-line purchase transactions, post sale returns can be difficult and expensive. For example, if a same item is found at a better price elsewhere or a better item is found, the customer 122, 124 is typically left with few options. On some web sites, if the item 152 has not yet been shipped, the order can be cancelled. If, on the other hand, the item 152 has been shipped, the customer 122, 124 must wait for the item 152 to arrive and decide whether to keep the item 152 and forego the better deal, return the item 152 and pay the return postage (which can be expensive), or attempt to sell the item 152 by himself in an aftermarket using an auction broker 130, such as eBay®. If the customer 122, 124 decides to return or resell the item 152, the customer 122, 124 typically must handle the shipping by himself, which can be expensive and burdensome.

### SUMMARY

A method for selling an item over a computer network includes offering an item for sale over a computer network and receiving a purchase request for the item from a customer. The item is contained in an inventory of a merchant. The method further includes noting that the customer has acquired an ownership right to the item, maintaining the item in the inventory, and ceasing to offer the item for sale.

Another embodiment of the method for selling an item over a computer network includes purchasing an ownership right to an item from a merchant, requesting that the merchant retain the item in an inventory of the merchant, and arranging for the item to be offered for sale.

### DESCRIPTION OF THE DRAWINGS

The preferred embodiments of the method and system for selling an item over a computer network will be described in detail with reference to the following figures, in which like numerals refer to like elements, and wherein:

FIGS. 1A and 1B illustrate a prior art on-line trading transaction;

FIG. 2 illustrates a system that enables a customer to sell an item over a computer network;

FIGS. 3-8 are flow charts illustrating different embodiments of a method for selling an item over a computer network; and

FIG. 9 illustrates exemplary hardware components of a computer that may be used in connection with the method for selling an item over a computer network.

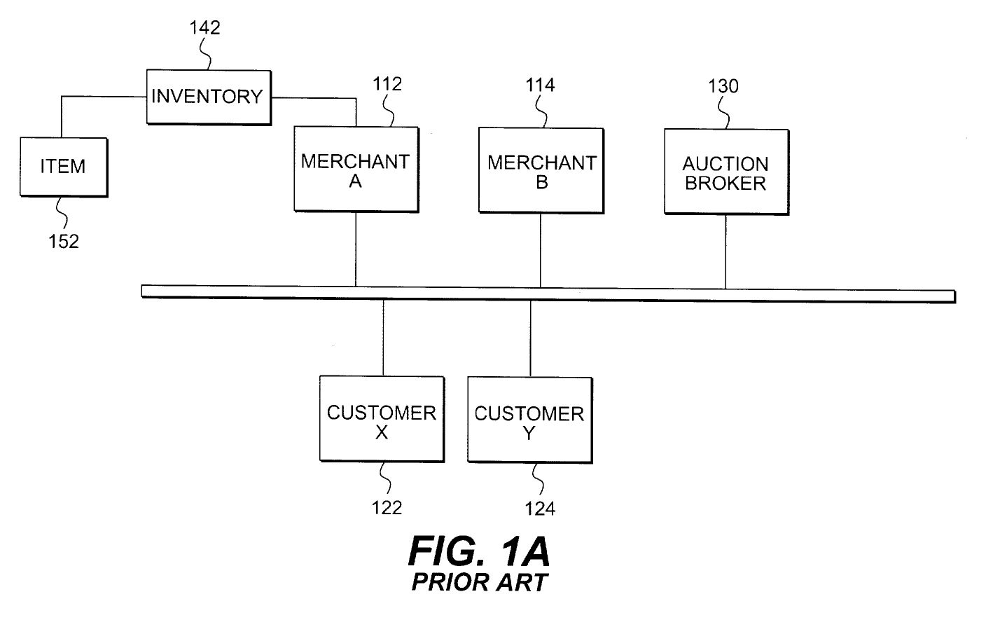

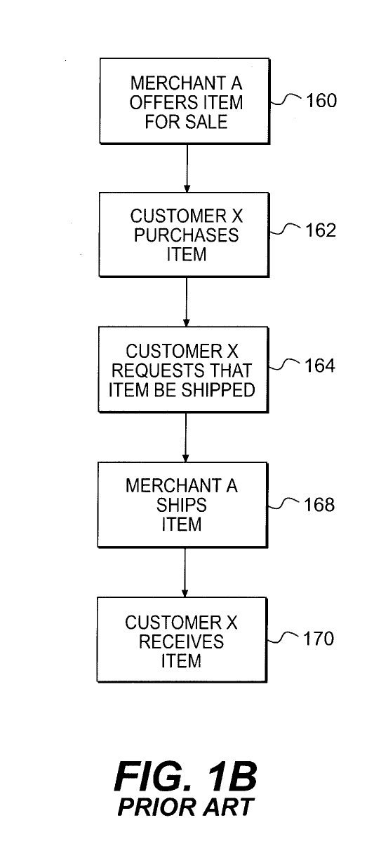

### DETAILED DESCRIPTION

A method for purchasing rights to resell an item offers for sale a right to have purchased items, articles, or products shipped at a later date. The method offers for sale an item's ownership, without altering the physical location of the item. In other words, a customer pays to own the item without acquiring possession of the item. A merchant that sells the item, or the merchant's supplier, may retain possession of the item until the customer takes possession. The method may set up a guarantee of turnaround time and a schedule for shipping costs associated with the delayed shipping. The right to resell the item may have a predefined lifetime, after which the item may be delivered to the customer, or a maintenance fee may be paid to keep the right to resell in effect. Alternatively, the turnaround guarantee may be weakened.

A merchant that sells items, articles, or products over the Internet may benefit by not having to process as many returns for dissatisfied customers. In addition, the merchant may sell more items to customers who would otherwise continue to shop around for better deals. By selling the right to the items in advance without shipping the items, the merchant may also obtain payment up front for future needs. The merchant may offer two prices for an item, i.e., a full but cancelable price and a discounted but non-cancelable price for future delivery. Additionally, the merchant may offer a premium price to hold a hard-to-find item.

A customer that purchases the right to resell an item may be a consumer or a retailer. If a consumer purchases the right to an item and later decides to obtain possession, the consumer may have the item delivered to himself or a third party. If on the other hand, a same item is found with a better price or a better item is found elsewhere, the consumer can sell back the right to the item to the original seller (merchant), for example, at a discount. Alternatively, the consumer can sell the right to another consumer on an aftermarket. If the item is later sold on an aftermarket, the consumer may charge a lower price because the consumer, acting as a seller, does not have to pay associated shipping cost.

The consumer may benefit because the consumer typically will not suffer “buyer's remorse” after discovering a better deal. The consumer may return the purchased item without having to pay any return postage or restocking fee. The consumer may also resell the purchased item readily on an aftermarket. In addition, the consumer may also obtain a discount for submitting non-cancelable orders. When buying gifts far in advance to lock in prices, the consumer may also benefit from having the gifts delivered to the recipient directly, yet reserving the right to cancel the order anytime before the delivery.

The customer may also be a retailer who, for example, sells a class of items without maintaining an inventory. The retailer may look for good deals on available web sites. The retailer may then purchase rights to resell items from the retailer's own web site. The retailer may choose to disclose or conceal the original seller of the items. The retailer may avoid the cost of acquiring physical possession of the items to be resold, both in terms of time and money. The retailer may also save shipping cost and delivery time by, for example, purchasing rights to resell items in another country to be shipped to a customer in that country.

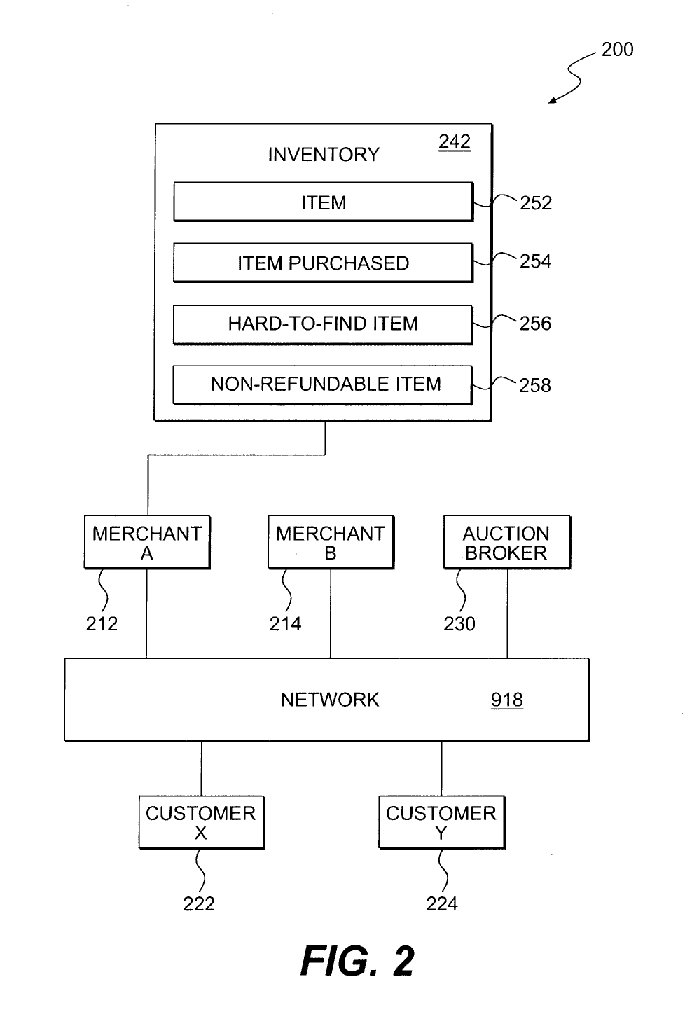

FIG. 2 illustrates an exemplary system 200 that enables a customer to resell an item over the Internet. A network 918 connects different customers, such as customer X 222 and customer Y 224, with merchants, such as merchant A 212, merchant B 214, and an auction broker 230. The customers 222, 224 may be individual consumers or retail stores that purchase products from the merchants 212, 214. Each merchant 212, 214 may have an inventory 242 that stocks items 252 being offered for sale. After the customers 222, 224 purchase an item, the item purchased 254 is retained in the inventory 242 until a future delivery date. The customers 222, 224 may resell the items purchased 254 anytime before the future delivery date. The customer 222, 224 may resell the items purchased 254 back to the initial seller, request the initial seller or another merchant to resell the items purchased 254, or resell the items purchased 254 in an auction sale using the auction broker 230.

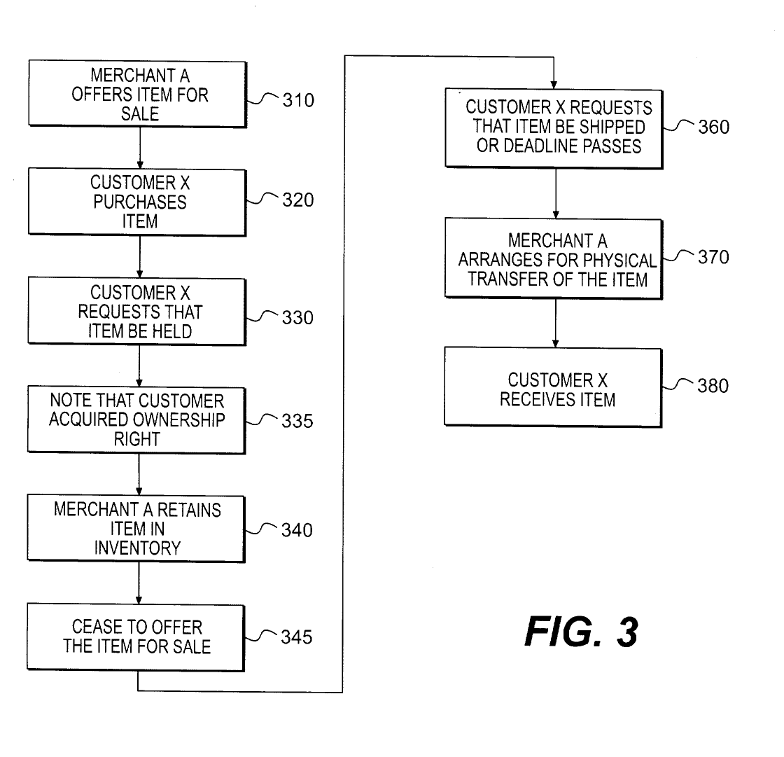

FIGS. 3-8 are flow charts illustrating different embodiments of the method for selling an item over a computer network. Referring to FIG. 3, a merchant A 212 offers an item 252 for sale (block 310). A customer X 222 purchases the item 252 (block 320) but requests that the physical item 252 be held by the merchant A 212 (block 330). The merchant A 212 may note that the customer X 222 has acquired ownership right to the item 252 (block 335). The merchant A 212 may retain the item 252 in the merchant's inventory 242 (block 340), but may remove the item 252 from a list of available products (block 345). The customer X 222 may pay a premium to have a hard-to-find item 256 (shown in FIG. 2) put on hold. The premium allows the customer X 222 to return the item purchased 254 at any time before delivery without penalty. Alternatively, the merchant A 212 may offer a discount for a non-returnable item 258 (shown in FIG. 2). At a future time, the customer X 222 may request that the item 252 be shipped to an address specified by the customer X 222 (block 360). The item 252 may also be shipped automatically after a pre-specified deadline passes (block 360). The merchant A 212 arranges for physical transfer of the item 252, and the customer X 222 receives the item 252 (blocks 370 and 380). The customer X 222 may also have the item 252 shipped to a third party.

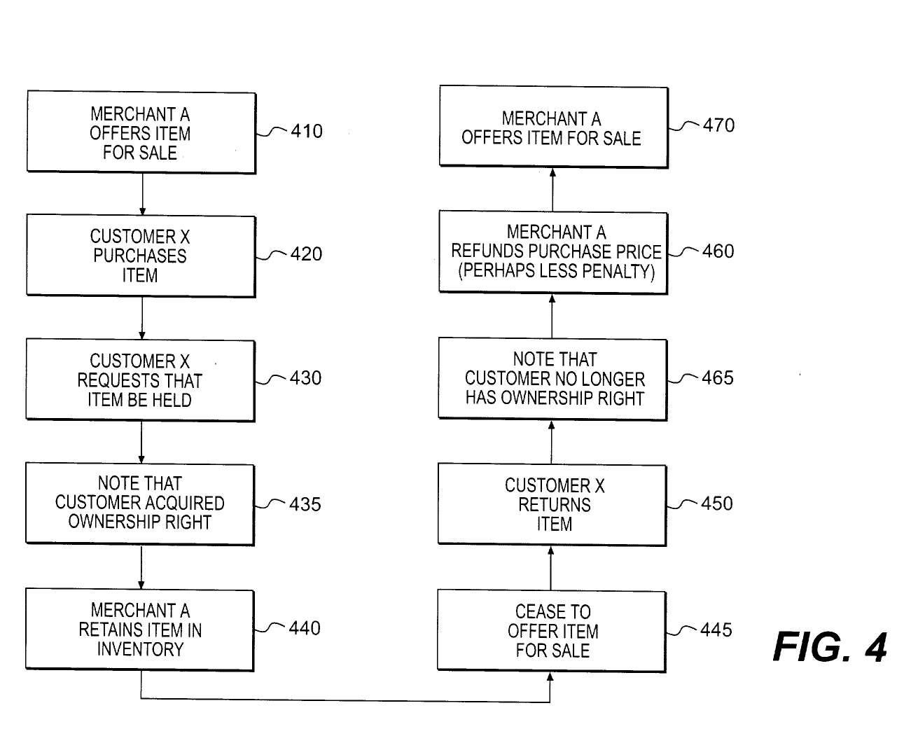

FIG. 4 illustrates an embodiment with a return transaction. Similar to the transaction shown in FIG. 3, the merchant A 212 offers an item 252 for sale (block 410). The customer X 222 purchases the item 252 (block 420) and requests that the physical item 252 be held (block 430). The merchant A 212 may note that the customer X 222 has acquired ownership right to the item 252 (block 435). The merchant A may retain the item 252 in the merchant's inventory 242 (block 440), but may remove the item 252 from a list of available products (block 445). Before shipment, the customer X 222 finds a better deal elsewhere and decides to return the item purchased 254 (block 450). The merchant A 212 may note that the customer X 222 no longer has ownership right to the item 252 (block 465). In this embodiment, the merchant A 212 may offer to buy back the item purchased 254 by the customer X 222 at a discount. In other words, the merchant A 212 may refund the purchase price less some penalty (block 460), and may offer the item 252 for sale again (block 470). The customer X 222 does not have to pay shipping fee to send the item 252 back, because the customer X 222 has not received the physical item 252. Similarly, the merchant A 212 does not have to process the return. While returns become easier and cheaper, more customers are willing to complete a purchase while still shopping around.

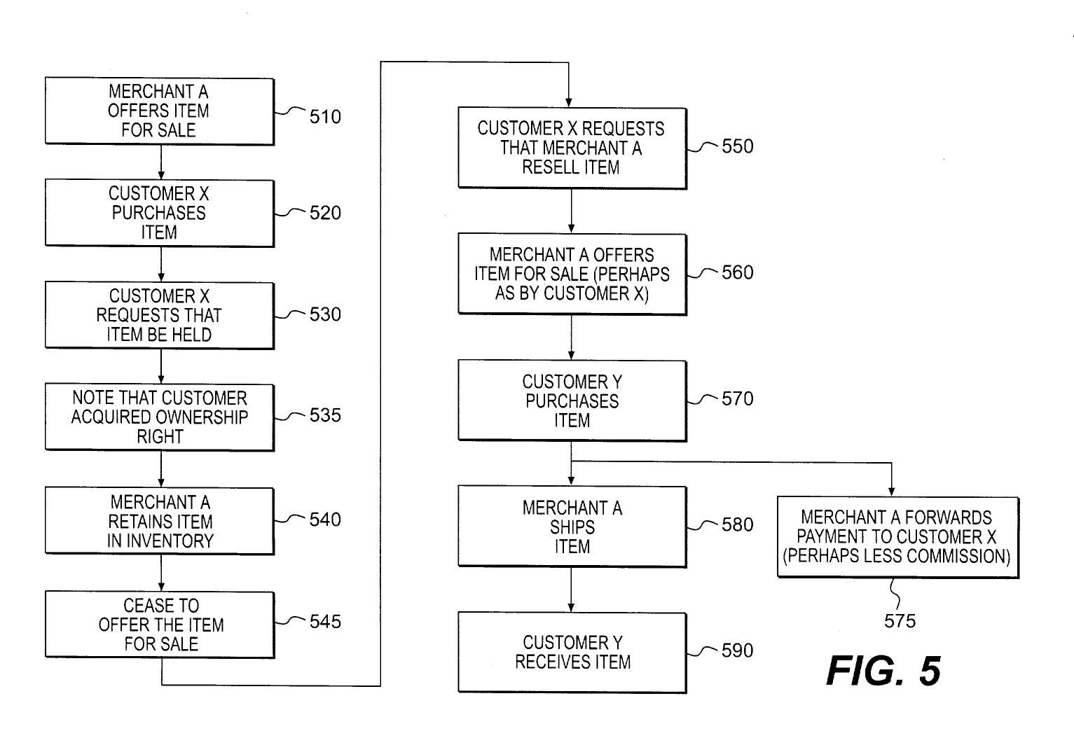

FIG. 5 illustrates another embodiment of the method for selling an item over a computer network. In this embodiment, the customer X 222 requests the merchant A 212 to resell the item 252. Similar to the transaction shown in FIG. 4, the merchant A 212 offers an item 252 for sale (block 510). The customer X 222 purchases the item 252 (block 520) and requests that the physical item 252 be held (block 530). The merchant A 212 may note that the customer X 222 has acquired ownership right to the item 252 (block 535). The merchant A may retain the item 252 in the merchant's inventory 242 (block 540), but may remove the item 252 from a list of available products (block 545). Before shipment, the customer X 222 finds a better deal elsewhere and requests that the merchant A 212 resell the item 252 (block 550). The merchant A 212 may offer the item 252 for sale, for example, in the customer X's name (block 560). Another customer Y 224 may purchase the item 252 from the merchant A 212 and may pay the merchant A 212 (block 570). The merchant A 212 then ships, and the customer Y 224 receives the item 252 (block 580, 590). The merchant A 212 may forward the payment received from the customer Y 224 to the customer X 222, after deducting a percentage based commission, for example (block 575).

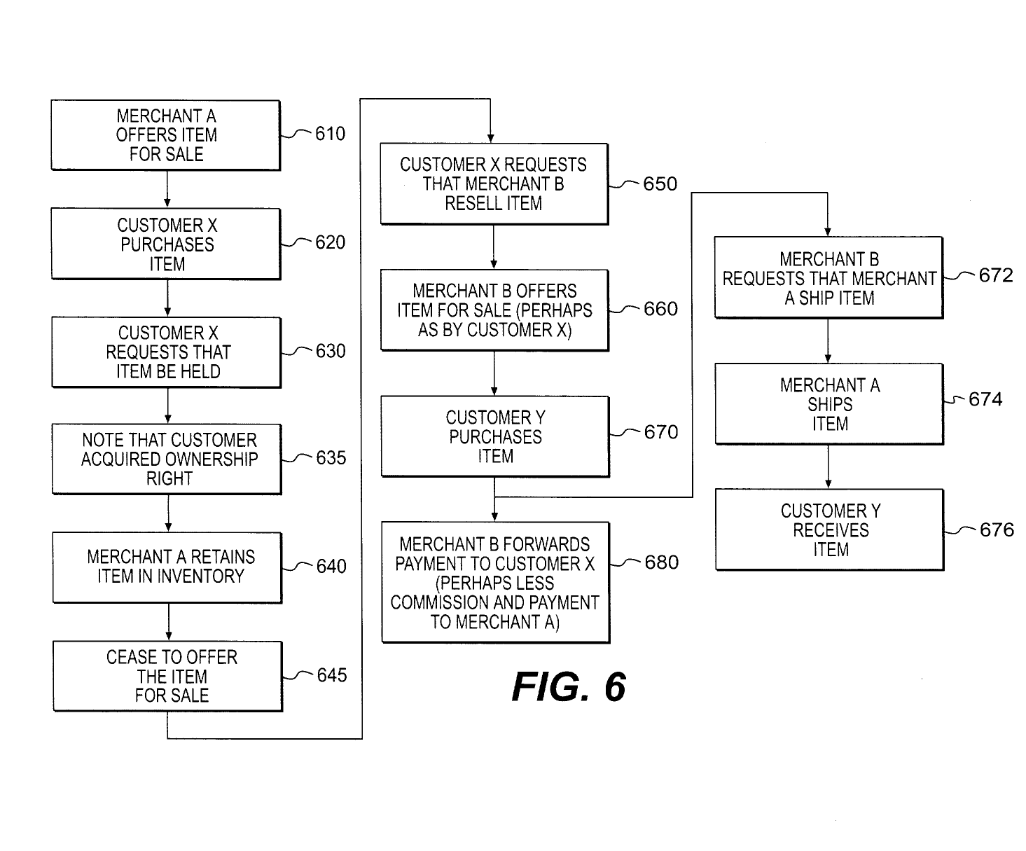

FIG. 6 illustrates yet another embodiment of the method for selling an item over a computer network. In this embodiment, the customer X 222 requests another merchant B 214 to resell the item 252. Similar to the transaction shown in FIG. 4, the merchant A 212 offers an item 252 for sale (block 610). The customer X 222 purchases the item 252 (block 620) and requests that the physical item 252 be held (block 630). The merchant A 212 may note that the customer X 222 has acquired ownership right to the item 252 (block 635). The merchant A may retain the item 252 in the merchant's inventory 242 (block 640), but may remove the item 252 from a list of available products (block 645). Before shipment, the customer X 222 finds a better deal elsewhere and requests that another merchant B 214 resell the item 252 (block 650). The merchant B 214 may offer the item 252 for sale, for example, in the customer X's name (block 660). Another customer Y 224 may purchase the item 252 from the merchant B 214 and may pay the merchant B 214 (block 670). The merchant B 214 then requests the merchant A 212 to ship the item 252 (block 672). The merchant A 212 ships, and the customer Y 224 receives the items (block 674, 676). The merchant B 214 may forward the payment received from the customer Y 224 to the customer X 222, after deducting a percentage based commission and a payment to the merchant A 212, for example (block 680).

To ensure that the merchant B 214 has the right to request that the merchant A 212 ship the item 252 (block 672), the merchant A 212 may require that the request be accompanied by a verifiable proxy certifying that right. The proxy is created by the customer X 222. In one embodiment, the proxy contains minimally information identifying the item 252 (such as a UPC code or a reference to the initial purchase transaction), an indication that the rights being shared include the right to request shipment for the item 252, and information (such as a public key) that can be used to verify a digital signature of the merchant B 214. The proxy is digitally signed by the customer X 222 using a private key. The private key corresponds to a public key known by the merchant A 212 to belong to the customer X 222. Upon receipt of the request to ship the item 252, the merchant A 212 verifies that the item in question is the one mentioned in the proxy. The merchant A 212 then ascertains the owner of the item 252, i.e., the customer X 222, and uses the customer X 222's public key to verify that the proxy was in fact signed by the customer X 222. The merchant A 212 then uses the public key contained within the proxy, i.e., the merchant B's information, to verify that the request to ship was signed by that entity.

In another embodiment, the merchant A 212 delivers to the customer X 222 a certificate that is digitally signed by the merchant A 212. The certificate contains information identifying the item 252, a public key associated with the customer X 222, and an indication that the rights being shared include the right to create a proxy for the right to request shipment for the item 252. The proxy, created and digitally signed by the customer X 222, contains the certificate (or a reference to it understandable by merchant A 212) and information (such as a public key) that can be used to verify a digital signature of the merchant B 214. Upon receipt of the request to ship the item 252, the merchant A 212 verifies that the item in question is the one mentioned in the certificate contained in the proxy. The merchant A 212 then ascertains that the proxy was signed by the owner of the public key contained in the certificate contained in the proxy and that the request was signed by the owner of the public key contained in the proxy.

In still another embodiment, security may be ensured by requiring that the customer X 222 notify the merchant A 212 when the customer X 222 wishes to allow another entity to exercise one or more of its rights. Upon receipt of such notification, the merchant A 212 makes note of that fact.

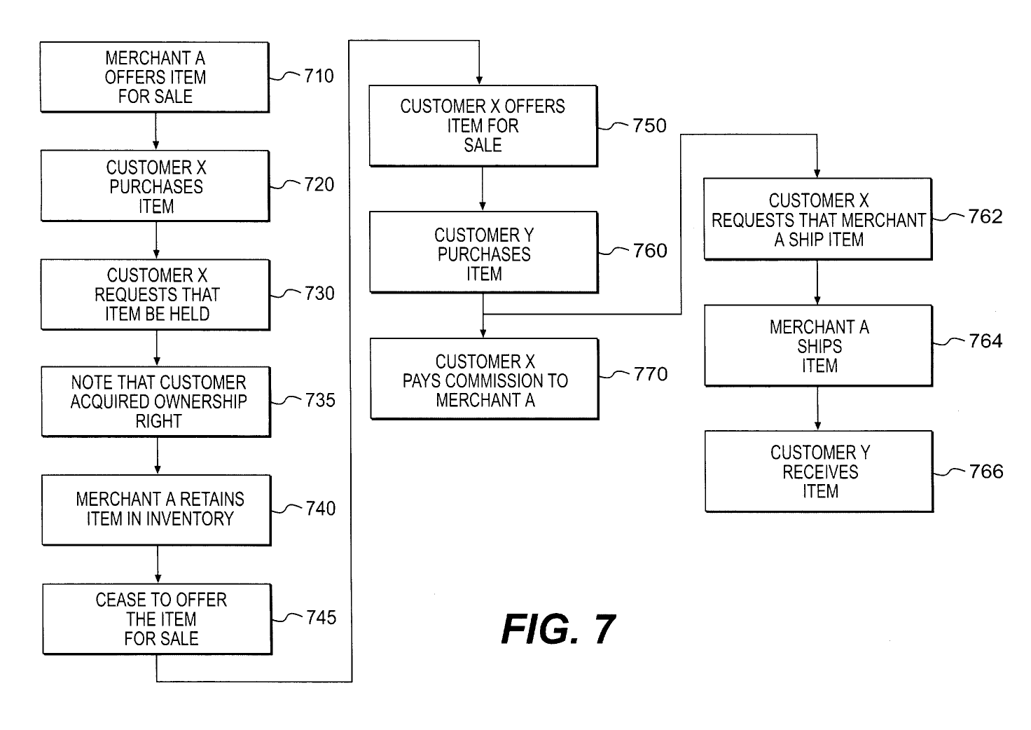

FIG. 7 illustrates still another embodiment of the method for selling an item over a computer network. In this embodiment, the customer X 222 attempts to resell the item 252 by himself or herself. Similar to the transaction shown in FIG. 4, the merchant A 212 offers an item 252 for sale (block 710). The customer X 222 purchases the item 252 (block 720) and requests that the physical item 252 be held (block 730). The merchant A 212 may note that the customer X 222 has acquired ownership right to the item 252 (block 735). The merchant A may retain the item 252 in the merchant's inventory 242 (block 740), but may remove the item 252 from a list of available products (block 745). Before shipment, the customer X 222 finds a better deal elsewhere and offers the item 252 for sale (block 750). Another customer Y 224 may purchase the item 252 from the customer X 222 and may pay the customer X 222 (block 760). The customer X 222 then requests the merchant A 212 to ship the item 252 (block 762). The merchant A 212 ships, and the customer Y 224 receives the items (block 764, 766). The customer X may pay a percentage based commission, for example, to the merchant A 212 (block 770). Alternatively, the customer Y 224 may purchase the right to resell the item 252 with a future delivery date, and resell the item 252 on an aftermarket if a better price is found elsewhere.

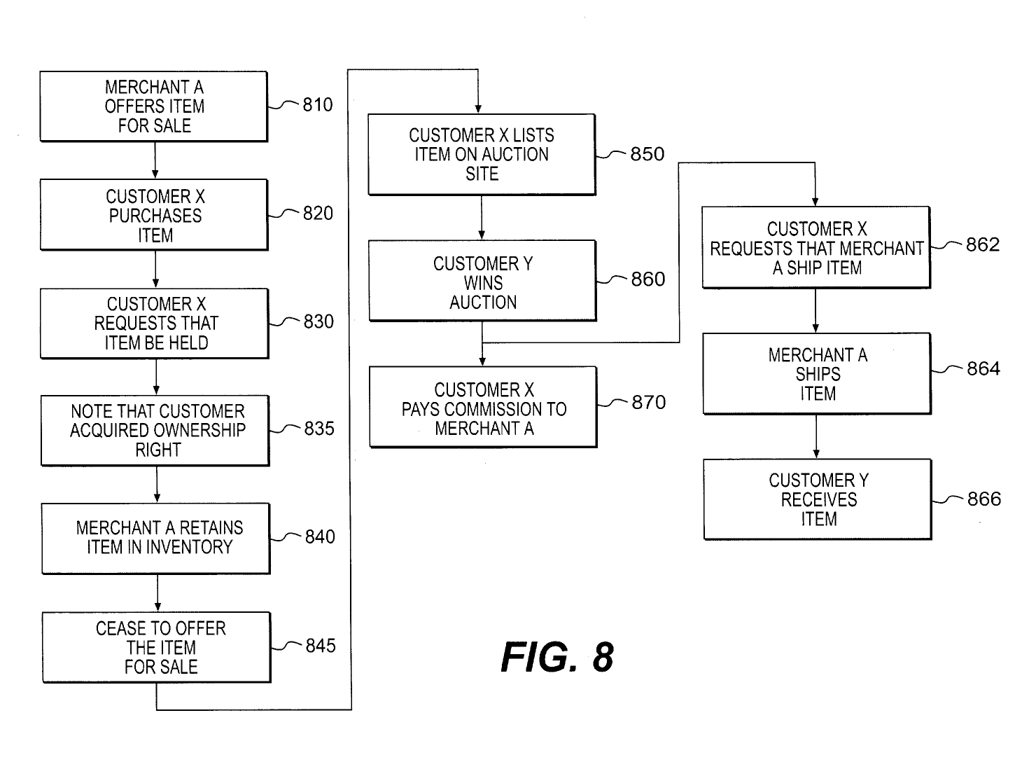

FIG. 8 illustrates yet still another embodiment of the method for selling an item over a computer network. In this embodiment, the customer X 222 attempts to resell the item 252 in an auction sale. Similar to the transaction shown in FIG. 4, the merchant A 212 offers an item 252 for sale (block 810). The customer X 222 purchases the item 252 (block 820) and requests that the physical item 252 be held (block 830). The merchant A 212 may note that the customer X 222 has acquired ownership right to the item 252 (block 835). The merchant A may retain the item 252 in the merchant's inventory 242 (block 840), but may remove the item 252 from a list of available products (block 845). Before shipment, the customer X 222 finds a better deal elsewhere and offers the item 252 for sale in an action (block 850). In this embodiment, the system 200 acts as a clearinghouse for the right to resell, offering to sell preferentially out of such stock. Another customer Y 224 may win the auction sale and pay the customer X 222 (block 860). The customer X 222 then requests the merchant A 212 to ship the item 252 (block 862). The merchant A 212 ships, and the customer Y 224 receives the items (block 864, 866). The customer X may pay a percentage based commission, for example, to the merchant A 212 (block 870).

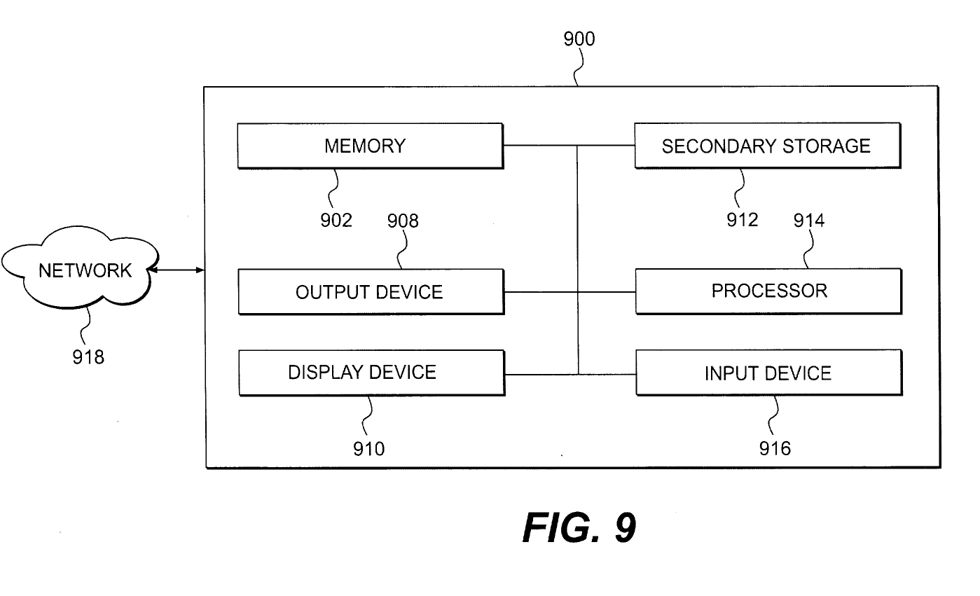

FIG. 9 illustrates exemplary hardware components of a computer 900 that may be used in connection with the method for selling an item over a computer network. The computer 900 includes a connection with the network 918 such as the Internet or other type of computer or telephone network. The computer 900 typically includes a memory 902, a secondary storage device 912, a processor 914, an input device 916, a display device 910, and an output device 908.

The memory 902 may include random access memory (RAM) or similar types of memory. The secondary storage device 912 may include a hard disk drive, floppy disk drive, CD-ROM drive, or other types of non-volatile data storage, and may correspond with various databases or other resources. The processor 914 may execute information stored in the memory 902, the secondary storage 912, or received from the Internet or other network 918. The input device 916 may include any device for entering data into the computer 900, such as a keyboard, keypad, cursor-control device, touch-screen (possibly with a stylus), or microphone. The display device 910 may include any type of device for presenting visual image, such as, for example, a computer monitor, flat-screen display, or display panel. The output device 908 may include any type of device for presenting data in hard copy format, such as a printer, and other types of output devices including speakers or any device for providing data in audio form. The computer 900 can possibly include multiple input devices, output devices, and display devices.

Although the computer 900 is depicted with various components, one skilled in the art will appreciate that the computer 900 can contain additional or different components. In addition, although aspects of an implementation consistent with the method for selling an item over a computer network are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 900 to perform a particular method.

While the method and apparatus for selling an item over a computer network have been described in connection with an exemplary embodiment, those skilled in the art will understand that many modifications in light of these teachings are possible, and this application is intended to cover any variations thereof.

What is claimed is:

1. A method for selling an item over a computer network, comprising:
offering an item for sale over a computer network, wherein the item is contained in an inventory of a merchant;
receiving a purchase request for the item from a customer;
noting that the customer has acquired an ownership right to the item; and
maintaining the item in the inventory.

2. The method of claim 1, further comprising ceasing to offer the item for sale.

3. The method of claim 1, further comprising:
receiving a request for shipment from the customer; and
arranging for a physical transfer of the item to a location specified by the customer.

4. The method of claim 1, further comprising establishing a contract with the customer regarding maintenances of the item in the inventory.

5. The method of claim 4, further comprising arranging for a physical transfer of the item to a location specified by the customer upon an arrival of a date specified in the contract.

6. The method of claim 4, wherein the contract specifies a schedule of payments from the customer for maintaining the item in the inventory.

7. The method of claim 1, further comprising:
receiving a request for return from the customer;
noting that the customer no longer has the ownership right to the item; and
offering the item for sale.

8. The method of claim 7, further comprising charging the customer a penalty fee.

9. The method of claim 1, further comprising:
receiving a request to resell the item from the customer;
continuing to offer the item for sale;
receiving a purchase request for the item from a second customer;
receiving a payment from the second customer; and
transferring a portion of the payment to the customer.

10. The method of claim 9, further comprising:
noting that the second customer has acquired an ownership right to the item;
maintaining the item in the inventory; and
ceasing to offer the item for sale.

11. The method of claim 9, wherein the step of receiving the purchase request for the item from the second customer comprises receiving a purchase request for any one of a set of items matching a description matched by the item.

12. The method of claim 1, further comprising:
receiving a request from the customer to transfer the ownership right to a second customer; and
transferring the ownership right to the second customer.

13. The method of claim 1, wherein the step of offering comprises advertising two prices for the item: a first price for immediate delivery and a second price for transfer of ownership.

14. The method of claim 1, further comprising providing a means to construct a proxy to allow a third party to exercise an ownership right on behalf of the customer.

15. A method for selling an item over a computer network, comprising:
purchasing an ownership right to an item from a merchant;
requesting that the merchant retain the item in an inventory of the merchant; and
arranging for the item to be offered for sale.

16. The method of claim 15, wherein the step of arranging comprises requesting that the merchant sell the item.

17. The method of claim 15, wherein the step of arranging comprises offering the item for sale, and the method further comprising receiving a purchase request for the item from a customer;

18. The method of claim 17, further comprising requesting that the merchant arrange for a physically transfer of the item to a location specified by the customer.

19. The method of claim 17, further comprising requesting that the merchant transfer the ownership right to the customer.

20. The method of claim 17, wherein the step of offering comprises listing the item in an auction, and wherein the step of receiving the purchase request comprises receiving notification the auction has been won.

21. The method of claim 17, wherein the step of offering comprises requesting that a second merchant offer the item for sale.

22. The method of claim 15, wherein the step of arranging comprises:
requesting that a second merchant offer the item for sale;
allowing the second merchant to exercise an ownership right on behalf of the customer.

23. The method of claim 22, wherein the step of allowing comprises generating a proxy.

24. A system for selling an item over a computer network, comprising:
means for offering an item for sale over a computer network, wherein the item is contained in an inventory of a merchant;
means for receiving a purchase request for the item from a customer; and
means for recording ownership rights pertaining to the item,
wherein upon a receipt of a purchase request for the item, the system records that the customer has acquired an ownership right to the item, maintains the item in the inventory, and ceases to offer the item for sale.

25. The system of claim 24, further comprising means for receiving a request for shipment from the customer, wherein upon a receipt of a shipment request, the system arranges for a physical transfer of the item to a location specified by the customer.

26. The system of claim 24, further comprising means for receiving a request for return from the customer, wherein upon a receipt of a return request, the system records that the customer no longer has the ownership right to the item and offers the item for sale.

27. The system of claim 24, further comprising:
means for receiving a request to resell the item from the customer, wherein upon a receipt of a resell request, the system continues to offer the item for sale;
means for receiving a purchase request for the item from a second customer; and
means for receiving a payment from the second customer, wherein upon a receipt of the payment, the system transfers a portion of the payment to the customer.

28. The system of claim 27, wherein upon a receipt of the purchase request from the second customer, the system records that the second customer has acquired an ownership right to the item, maintains the item in the inventory, and ceases to offer the item for sale.

29. The system of claim 24, further comprising means for receiving a request from the customer to transfer the ownership right to a second customer, wherein upon a receipt of a transfer request, the system transfers the ownership right to the second customer.
